(19) United States
(12) Patent Application Publication
(10) Pub. No.: US 2006/0001346 A1
(43) Pub. Date: Jan. 5, 2006

(54) System and method for design of projector lamp

(76) Inventors: James Scott Vartuli, Rexford, NY (US); Stephen Thomas Tedeschi, Schenectady, NY (US); Luana Emiliana lorio, Clifton Park, NY (US); Bruce Alan Knudsen, Amsterdam, NY (US); Carl Edward Erikson, Schenectady, NY (US); James Anthony Brewer, Scotia, NY (US); David Osborn Wharmby, West Yorkshire (GB); Bernard Patrick Bewlay, Schenectady, NY (US)

Correspondence Address: Patrick S. Yoder;FLETCHER YODER, P.O. Box 692289, Houston, TX, 77269-2289, US

(21) Appl. No.: 10/880,801

(22) Filed: Jun. 30, 2004

(51) Int. Cl. H01J 5/48; H01J 5/50; H01J 9/00

(52) U.S. Cl. 313/318.01; 313/318.08; 313/318.03; 445/26

(57) ABSTRACT

A lamp comprising an arc envelope and an end structure coupled to the arc envelope, and wherein the end structure comprises at least one opening adapted to support an arc electrode and to receive a dosing material into the arc envelope.

### BACKGROUND

The invention relates generally to the field of lighting systems and, more particularly, to high-intensity discharge (HID) lamps. Specifically, embodiments of the present technique include a hermetically sealed lamp having improved dosing, sealing, and electrode mounting features.

High-intensity discharge lamps are often formed from a ceramic tubular body or arc tube that is sealed to one or more end structures. The end structures are often sealed to this ceramic tubular body using a seal glass, which has physical and mechanical properties matching those of the ceramic components and the end structures. Sealing usually involves heating the assembly of the ceramic tubular body, the end structures and the seal glass, to induce melting of the seal glass and a reaction with the ceramic bodies to form a strong chemical and physical bond. The ceramic tubular body and the end structures are often made of the same material, such as polycrystalline alumina (PCA). However, certain applications may require the use of different materials for the ceramic tubular body and the end structures. In either case, various stresses may arise due to the sealing process, the interface between the joined components, and the materials used for the different components. For example, the component materials may have different mechanical and physical properties, such as different coefficients of thermal expansion (CTE), which can lead to residual stresses and sealing cracks. These potential stresses and sealing cracks are particularly problematic for high-pressure lamps.

Additionally, the geometry of the interface between the ceramic tubular body and the end structures also may contribute to the foregoing stresses. For example, the end structures are often shaped as a plug or a pocket, which interfaces both the flat and cylindrical surfaces of the ceramic tubular body. If the components have different coefficients of thermal expansion and elastic properties, then residual stresses arise because of the different strains that prevent relaxation of the materials to stress-free states. For example in the case of the plug type end structure, if the plug has a lower coefficient of thermal expansion than the ceramic tubular body and seal glass, then compressive stresses arise in the ceramic-seal glass region while tensile stresses arise in the plug region.

Other components of the lamp further complicate the assembly of the lamp, and can further degrade the sealing and structural characteristics of the lamp. For example, existing lamps generally have a technique for injecting a dosing material, such as mercury or any rare gas or a halide, such as bromine, or a rare-earth metal halide. Unfortunately, this complicates the sealing process for the lamp. In other words, the lamp is typically heated to a temperature that melts a seal material, e.g., seal glass, but this heating process needs to maintain a temperature of the lamp that is not too hot to evaporate the dose (e.g., mercury and halide).

In addition, existing lamps generally have an arc electrode, which is mounted to the end structure. In operation, the mounted position of the arc electrode can affect the creation and characteristics of an arc within the lamp. Unfortunately, it is relatively difficult to mount the arc electrode at the desired location on the end structure. Moreover, existing mounting techniques may involve the application of heat, which can cause stress cracks in the lamp and can embrittle the arc electrode.

Accordingly, a technique is needed to provide a lighting system with improved dosing, sealing, and electrode mounting features.

### BRIEF DESCRIPTION

In accordance with certain embodiments of the present technique, a system and method for hermetically sealing a lamp is disclosed. Certain embodiments of the lamp have an arc envelope and, also, an end structure bonded to the arc envelope at an open end. The end structure also has a dosing passageway extending into the arc envelope. In other embodiments, a lighting device is provided with an end structure adapted to close an open end of an arc envelope, and a dosing tube diffusion bonded to the end structure. Another embodiment of the lighting device has an arc envelope and an end structure diffusion bonded to an open end of the arc envelope. In another embodiment, the present technique includes means for mounting the arc electrode to the end structure and sealing the end structure with the open end of the arc envelope. In a further embodiment, the present technique includes a means for doing the arc envelope through the end structure sealed to the arc envelope and means for mounting the arc envelope.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary lamp having opposite end structures in accordance with embodiments of the present technique;

FIG. 2 is an exploded cross-sectional side view of an end structure, an arc electrode exploded from a receptacle in the end structure, and a plug member exploded from a dosing passage through the end structure in accordance with embodiments of the present technique;

FIG. 3 is a cross-sectional view of the end structure of FIG. 2 illustrating the arc electrode shrunk-fit into the receptacle and the dosing passageway in accordance with embodiments of the present technique;

FIG. 4 is a flow chart illustrating a process of manufacturing the lamp of FIG. 1 in accordance with embodiments of the present technique;

FIG. 5 is a flow chart illustrating another process of manufacturing the lamp of FIG. 1 in accordance with embodiments of the present technique;

FIG. 6 is a cross-sectional view of the lamp of FIG. 1 having an arc envelope, end structures plugged into opposite ends of the arc envelope, an arc electrode shrunk-fit into each of the end structures, and a plug member exploded from a dosing passageway in one of the end structures in accordance with embodiments of the present technique;

FIG. 7 is a cross-sectional view of an alternative lamp the having an arc envelope, end structures butt-sealed to opposite ends of the arc envelope, an arc electrode shrunk-fit into each of the end structures, and a plug member exploded from a dosing passageway in one of the end structures in accordance with embodiments of the present technique;

FIG. 8 is a diagrammatical view of a dosing system for the lamp of FIG. 6 in accordance with embodiments of the present technique;

FIG. 9 is a cross-sectional view of the lamp of FIG. 6 having a dosing material disposed within the arc envelope and the plug member disposed within the dosing passageway in accordance with embodiments of the present technique;

FIG. 10 is a cross-sectional view of an alternative end structure having a dosing passageway, a dosing tube exploded from the dosing passageway, a coil exploded from the dosing tube, and an arc electrode exploded from the coil in accordance with embodiments of the present technique;

FIG. 11 is a cross-sectional view of the end structure of FIG. 10 having the dosing tube hermetically sealed within the dosing passageway and a protective layer disposed over an interior surface of the end structure in accordance with embodiments of the present technique;

FIG. 12 is a cross-sectional view of a lamp having an arc envelope, end structures plugged into opposite ends of the arc envelope, an arc electrode shrunk-fit into one of the end structures, a dosing tube hermetically sealed within a dosing passageway of another one of the end structures as illustrated in FIG. 11, and a dosing system coupled to the dosing tube in accordance with embodiments of the present technique;

FIG. 13 is a cross-sectional view of the lamp of FIG. 12 having a coil disposed within the dosing tube, an arc electrode disposed within the coil, and a sealed portion extending across the dosing tube in accordance with embodiments of the present technique;

FIG. 14 is a cross-sectional view of a lamp having an arc envelope, end structures butt-sealed to opposite ends of the arc envelope, an arc electrode shrunk-fit into one of the end structures, and a dosing tube, coil, and arc electrode hermetically sealed to a dosing passageway of another one of the end structures in accordance with embodiments of the present technique; and

FIG. 15 is a flow chart illustrating an exemplary process of manufacturing the lamp of FIGS. 13 and 14 in accordance with embodiments of the present technique.

### DETAILED DESCRIPTION

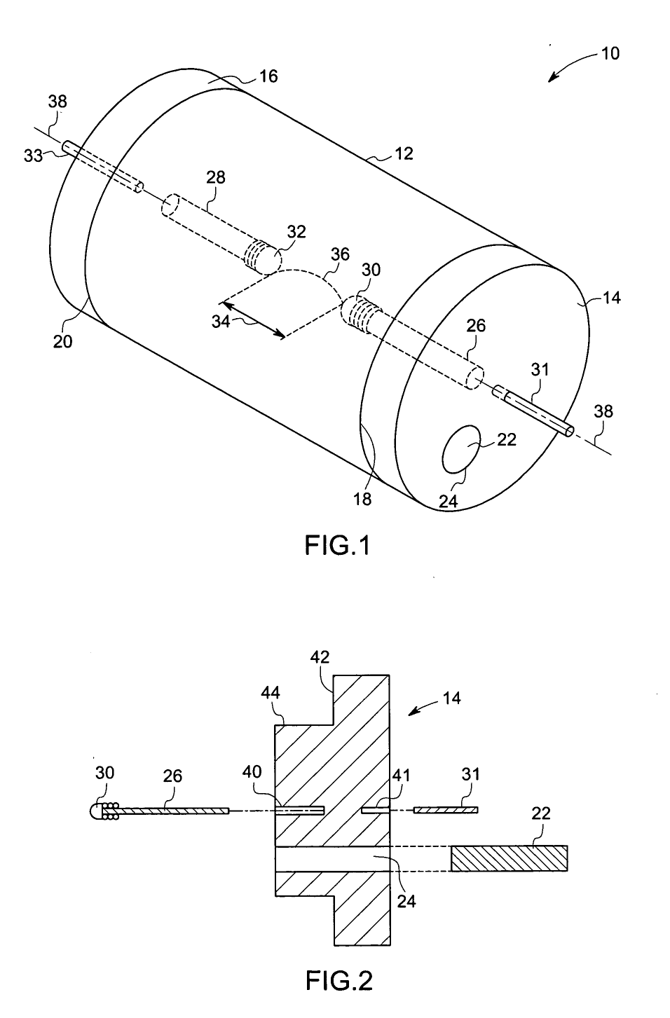

Turning now to the drawings, FIG. 1 is a perspective view of an exemplary lamp 10 in accordance with certain embodiments of the present technique. As illustrated, the lamp 10 comprises a hermetically sealed assembly of a hollow body or arc envelope 12 and end structures 14 and 16 coupled to opposite ends 18 and 20 of the arc envelope 12. These and other components of the lamp 10 are formed from a variety of materials, which are either identical or different from one another. For example, different embodiments of the arc envelope 12 are formed from a variety of transparent ceramics and other materials, such as yttrium-aluminum-garnet, ytterbium-aluminum-garnet, microgram polycrystalline alumina (μPCA), alumina or single crystal sapphire, yttria, spinel, and ytterbia. Other embodiments of the arc envelope 12 are formed from conventional lamp materials, such as polycrystalline alumina (PCA). Turning to the end structures 14 and 16 of the lamp 10, these components are formed from a variety of ceramics and other suitable materials, such as niobium, niobium coated with a corrosion resistant material (e.g., a halide resistant material), a cermet (e.g., a zirconia-stabilized cermet, an alumina-tungsten, etc.), and other conductive or non-conductive materials depending on the particular embodiment described in detail below.

Regarding the geometry and sealing characteristics of the lamp 10, certain embodiments of the arc envelope 12 comprise a hollow cylinder, a hollow oval shape, a hollow sphere, a bulb shape, a rectangular shaped tube, or another suitable hollow transparent body. Moreover, the end structures 14 and 16 may have a variety of geometries, such as a plug-shaped geometry that at least partially extends into the arc envelope 12. Alternatively, some embodiments of the end structures 14 and 16 have a substantially flat mating surface, which seals against the opposite ends 18 and 20 without extending into the arc envelope 12. In other words, the ends structures 14 and 16 butt-seal against the opposite ends 18 and 20. In addition to these structural geometries, some embodiments of the lamp 10 have a seal material applied between the end structures 14 and 16 and opposite ends 18 and 20 of the arc envelope 12. These seal materials can include a sealing glass, such as calcium aluminate, dysprosia-alumina-silica, magnesia-alumina-silica, and yttria-calcia-alumina. Other potential non-glass seal materials include niobium-based brazes. In other embodiments, the end structures 14 and 16 are diffusion bonded to opposite ends 18 and 20 of the arc envelope 12 via material diffusion without using any seal material. For example, localized heating (e.g., a laser) may be applied to the interface between the end structures 14 and 16 and the opposite ends 18 and 20 to bond the materials together, thereby forming a hermetical seal. In certain embodiments, the end structures 14 and 16 comprise ceramic parts, such that the end structures 14 and 16 and the arc envelope 12 can be co-sintered together.

The illustrated lamp 10 also includes a plug member 22 disposed in a dosing passageway 24 extending through the end structure 14. As discussed in further detail below, the lamp 10 is filled with a dosing material through the dosing passageway 24. For example, certain embodiments of the dosing material comprise a rare gas and mercury. Other embodiments of the dosing material further comprise a halide, such as bromine, or a rare-earth metal halide. The dosing passageway 24 is subsequently sealed by the plug member 22. For example, the plug member 22 can be sealed by a seal material, diffusion bonding (e.g., using localized heating), or other suitable sealing techniques. In the illustrated embodiment, the plug member 22 comprises a material, such as a cermet, having a coefficient of thermal expansion substantially similar or identical to that of the end structure 14.

The illustrated lamp 10 also includes arc electrodes 26 and 28 having arc tips 30 and 32, respectively. These arc electrodes 26 and 28 are mounted at the interior of the end structures 14 and 16, respectively. At the exterior, the lamp also includes lead wires 31 and 33, which are mounted to the end structures 14 and 16, respectively. In certain embodiment, the arc electrodes 26 and 28 comprise tungsten or Molybdenum. However, other materials are within the scope of the present technique. The arc electrodes 26 and 28 are mounted to the end structures 14 and 16, such that the arc tips 30 and 32 are separated by a gap 34 to create an arc 36 during operation of the lamp 10. For example, as discussed in detail below, the arc electrodes 26 and 28 can be shrink-fit into receptacles in the end structures 14 and 16, respectively. In the illustrated embodiment, the arc tips 30 and 32 are oriented along the centerline 38 of the arc envelope 12. However, alternative embodiments of the arc electrodes 26 and 28 position the arc tips 30 and 32 offset from the centerline 38, such that the arc 36 is substantially centered within the arc envelope 12. For example, alternative arc electrodes 26 and 28 may be angled outwardly from the centerline 38 and/or mounted to the end structures 14 and 16 at positions offset from the centerline 38.

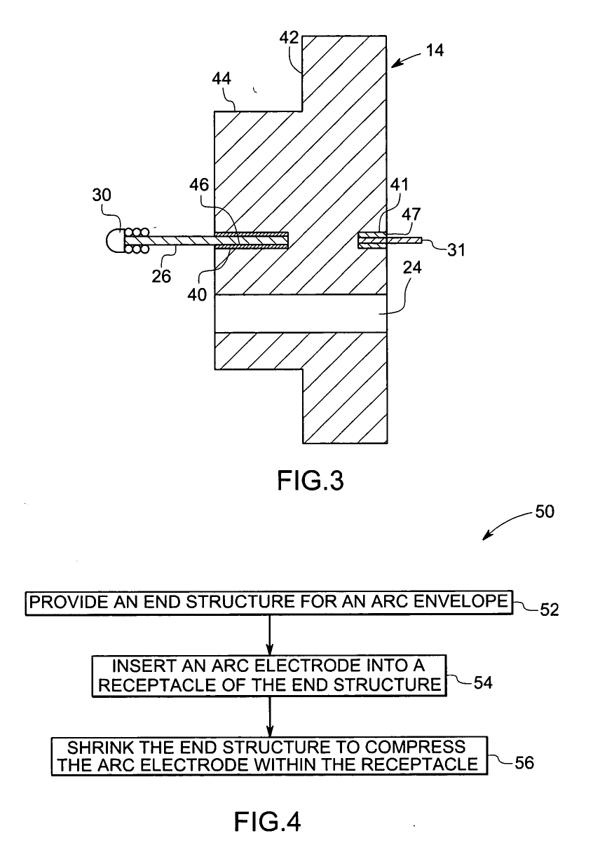

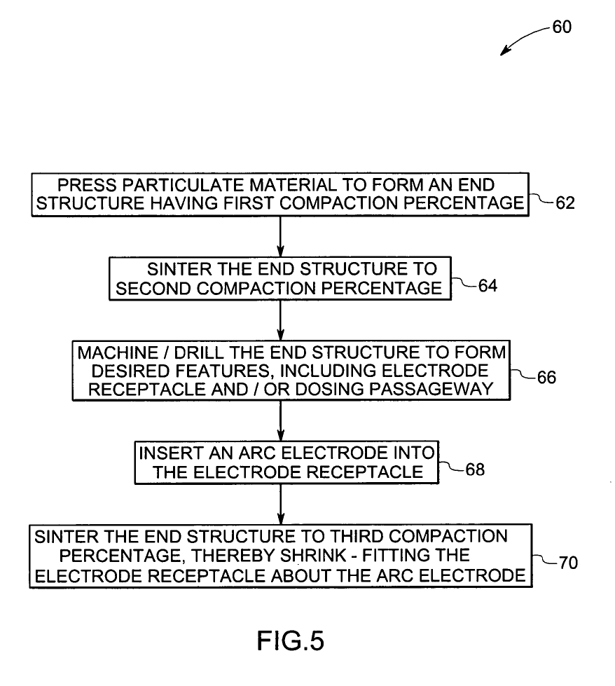

Turning now to the next drawing, FIG. 2 illustrates a cross-sectional side view of the end structure 14 of FIG. 1 having the plug member 22 exploded from the dosing passageway 24, the arc electrode 26 exploded from an electrode receptacle 40, and the lead wire 33 exploded from a lead receptacle 41 in accordance with embodiments of the present technique. The illustrated end structure 14 comprises an outer seal structure 42 and an inner seal structure 44. As discussed below with reference to FIG. 5, the outer seal structure 42 of the end structure 14 abuts and seals against the opposite end 18 of the arc envelope 12. The inner seal structure 44 plugs into the opposite end 18 and seals with an inner surface of the arc envelope 12 adjacent the opposite end 18. Referring back to FIG. 2, the end structure 14 comprises a porous form or uncondensed material, such as a pressed powder material (e.g., a cermet). After inserting the arc electrode 26 into the electrode receptacle 40 and inserting the lead wire 31 into the lead receptacle 41, the end structure 14 is further compacted or condensed to shrink the electrode receptacle 40 about the arc electrode 26 and to shrink the lead receptacle 41 about the lead wire 31 as illustrated in FIG. 3. In certain embodiments, the end structure 14 is formed by pressing a powder material to a first compaction percentage, sintering the pressed powder material to condense the end structure 14 to a second compaction percentage, drilling the end structure 14 to form the electrode receptacle 40 and the dosing passageway 24, inserting the arc electrode 26 into the electrode receptacle 40, and further sintering the end structure 14 to condense the end structure 14 to a third compaction percentage at which the electrode receptacle 40 is shrunk about the arc electrode 26 as illustrated in FIG. 3. As illustrated in FIG. 3, the latter sintering process facilitates sinter bonding between the arc electrode 26 and the end structure 14, as indicated by numeral 46. Similarly, this sintering process creates a sinter bond between the lead wire 31 and the lead receptacle 41, as indicated by numeral 47.

Turning now to FIGS. 4 and 5, exemplary processes are illustrated for manufacturing the end structures 14 and 16 described above with reference to FIGS. 1-3. FIG. 4 is a flow chart illustrating a process 50 for manufacturing the lamp 10 in accordance with embodiments of the present technique. As illustrated, the process 50 comprises providing an end structure for an arc envelope (block 52). For example, as described in detail below, the end structure comprises a porous form or partially compacted structure of a particulate material, such as a cermet powder. At block 54, the process 50 comprises inserting an arc electrode into a receptacle in the end structure. The process 50 then proceeds to condense the end structure to shrink-fit the arc electrode within the receptacle (block 56).

FIG. 5 illustrates another process 60 for manufacturing the lamp 10 in accordance with embodiment of the present technique. As illustrated, the process 60 begins by pressing a particulate material to form an end structure having a first compaction percentage (block 62). For example, a particulate material, such as a powder cermet, may be pressed approximately 45 to 65 percent, e.g., 55 percent, to form the end structures 14 and 16. At block 64, the process 60 proceeds to sinter the end structure to a second compaction percentage, which is greater than the first compaction percentage but not entirely condensed. In certain embodiments, the end structures 14 and 16 are sintered to partially condense the compacted particulate material, e.g., pressed powder cermet, thereby reducing the void space between particles of the compacted particulate material. For example, the sintering may heat the end structures 14 and 16 to approximately 1150 to 1350 degrees Celsius, e.g., 1250 degrees Celsius, to condense or conglomerate the particulate material by about an additional 10 to 20 percent, e.g., 16 percent. At block 66, the process 60 proceeds to machine and/or drill the end structure to form various features, including an electrode receptacle and/or a dosing passageway. At block 68, the process 60 then proceeds to insert an arc electrode into the electrode receptacle in the end structure. At block 70, the process 60 further sinters the end structure to a third compaction percentage, thereby shrink-fitting the electrode receptacle about the arc electrode. In certain embodiments, the sintering block 70 involves heating the end structure 14 to approximately 1700 to 2000 degrees Celsius, e.g., 1880 degrees Celsius. However, the specific temperatures and percentages described in the process 60 above may vary depending on the materials, pressures of pressing, durations of sintering, and other factors.

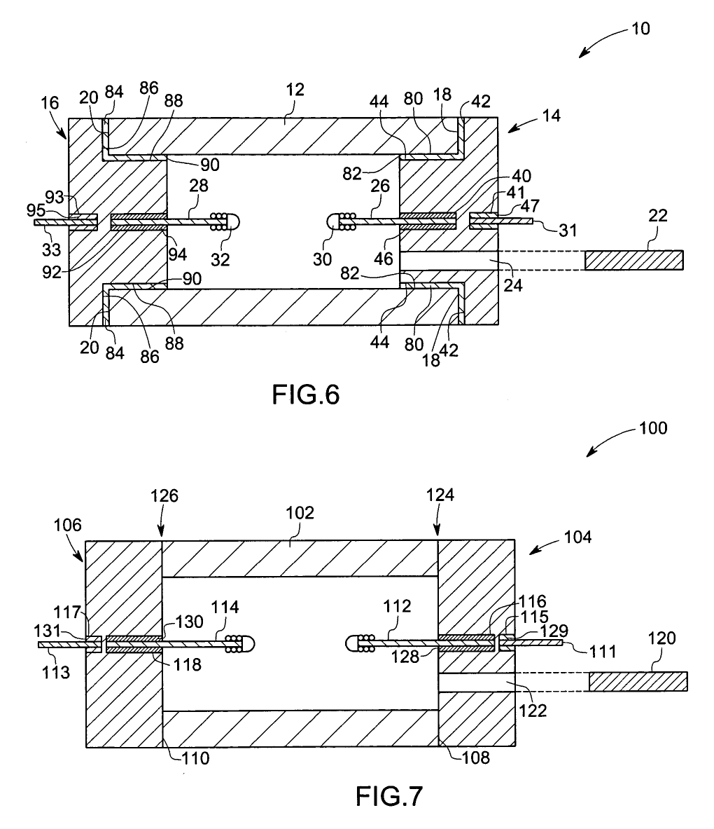

FIG. 6 is a cross-sectional view of the lamp of FIG. 1 having the arc envelope 12, end structures 14 and 16 plugged into opposite ends 18 and 20 of the arc envelope 12, the arc electrodes 26 and 28 shrunk-fit into each of the end structures 14 and 16, the lead wires 31 and 33 shrunk-fit into each of the end structures 14 and 16, and the plug member 22 exploded from the dosing passageway 28 in the end structure 14 in accordance with embodiments of the present technique. As illustrated, the end structure 14 is hermetically sealed with the arc envelope 12 by a seal material 80, which is disposed between the outer seal structure 42 and the arc envelope end 18 and between the inner seal structure 44 and an interior surface 82 of the arc envelope 12. Similarly, the end structure 16 is hermetically sealed with the arc envelope 12 by a seal material 84, which is disposed between an outer seal structure 86 of the end structure 16 and the arc envelope end 20 and between an inner seal structure 88 of the end structure 16 and an interior surface 90 of the arc envelope 12. Moreover, similar to the shrink-fit mounting of the arc electrode 26 into the electrode receptacle 40 the end structure 14, the arc electrode 28 is shrunk-fit into an electrode receptacle 92 within the end structure 16. In both of these end structures 14 and 16, elements 46 and 94 illustrate a sinter bond between the arc electrodes 26 and 28 and the electrode receptacles 40 and 92, respectively. In addition, the lead wires 31 and 33 are shrunk-fit into lead receptacles 41 and 93, such that the lead wires 31 and 33 are sinter bonded 47 and 95 into the end structures 14 and 16, respectively.

The seal materials 80 and 84 used for the foregoing bonds have characteristics at least partially attributed to the type of materials used for the various lamp components, e.g., the arc envelope 12 and end structures 14 and 16. For example, some embodiments of the lamp 10 are formed from a sapphire tubular arc envelope 12 bonded with polycrystalline alumina (PCA) end structures 14 and 16. By further example, some embodiments of the lamp 10 are formed from a YAG tubular arc envelope 12 bonded with cermet end structures 14 and 16, which have a similar coefficient of thermal expansion (CTE) as alumina (PCA). The seal materials 80 and 84 generally have a coefficient of thermal expansion (CTE) to control stresses at each interface between the arc envelope 12 and the end structures 14 and 16, e.g., each PCA/sapphire seal interface. For example, the seal materials 80 and 84 may comprise a niobium braze or a seal glass that minimizes tensile stresses developed upon cooling, e.g., a seal glass with a CTE value that is the average value of PCA and the a-axis or radial value of edge-defined-grown sapphire. In certain embodiments, localized heating is applied to the seal materials 80 and 84 to control the local microstructural development of the seal material, e.g., the seal glass.

FIG. 7 is a cross-sectional view of a lamp 100 having an arc envelope 102, end structures 104 and 106 butt-sealed to opposite ends 108 and 110 of the arc envelope 102, arc electrodes 112 and 114 shrunk-fit into electrode receptacles 116 and 118 in each of the end structures 104 and 106, lead wires 111 and 113 shrunk-fit into lead receptacles 115 and 117 in each of the end structures 104 and 106, and a plug member 120 exploded from a dosing passageway 122 in the end structure 104 in accordance with embodiments of the present technique. As illustrated, the lamp 100 has end-to-end or butt-seals 124 and 126 between the arc envelope 102 and the end structures 104 and 106, respectively. As illustrated, the end structures 104 and 106 are hermetically sealed with the arc envelope 102 by diffusion bonding of the materials at the interface between the end structures 104 and 106 and the arc envelope 102. In certain embodiment, localized heating, such as a laser, may be applied to this interface to facilitate diffusion bonding to form these butt-seals 124 and 126. Alternatively, the illustrated butt-seals 124 and 126 can include a seal material 841, such as described in detail above. In both of the end structures 104 and 106, elements 128 and 130 illustrate a sinter bond between the arc electrodes 112 and 114 and the electrode receptacles 116 and 118, respectively. Similarly, elements 129 and 131 illustrate a sinter bond between the lead wires 111 and 113 and the lead receptacles 115 and 117, respectively.

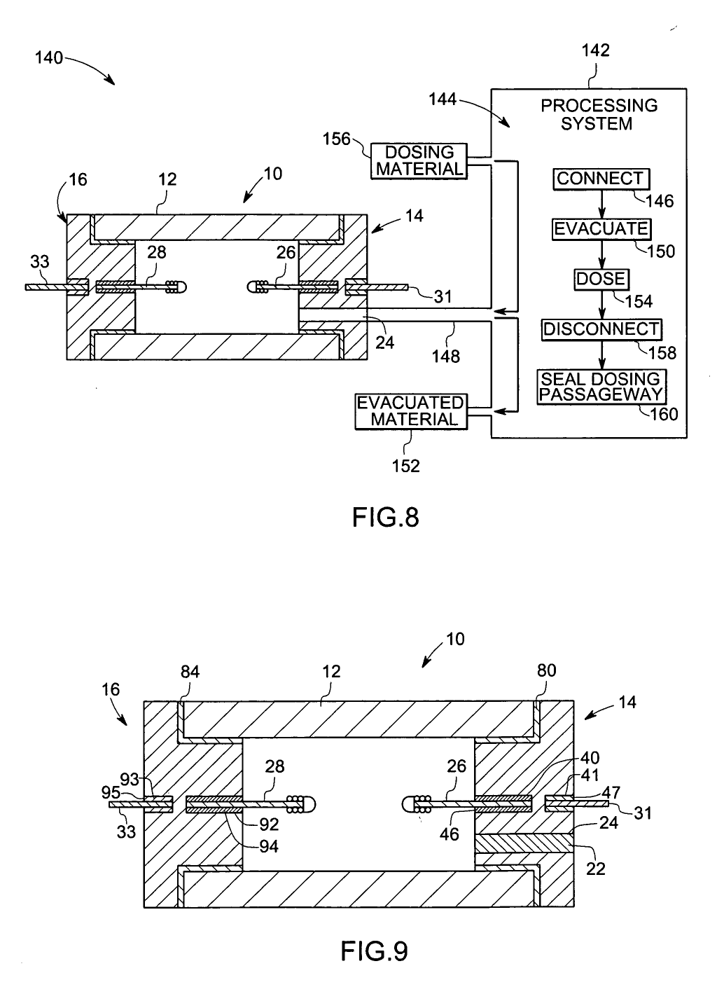

FIG. 8 is a diagrammatical view of a system 140 for dosing the lamp 10 of FIG. 6 in accordance with embodiments of the present technique. As illustrated in FIG. 8, the lamp 10 of FIG. 6 is coupled to a processing system 142 having a dosing process 144, which facilitates dosing the lamp 10 prior to sealing the plug member 22 into the dosing passageway 24. At block 146, the process 144 begins by connecting the processing system 142 with the dosing passageway 24 of the lamp 10. For example, tubing 148 can be connected between the processing system 142 and the dosing passageway 24. At block 150, the process 144 evacuates material 152 from the lamp 10. At block 154, the process 144 injects a dosing material 156 into the lamp 10. At block 158, the process 144 proceeds to disconnect the processing system 142 from the dosing passageway 24 of the lamp 10. The process 144 also seals the dosing passageway 24 with the plug member 22 at block 160. FIG. 9 is a cross-sectional view of the lamp 10 of FIG. 6 having the dosing material 156 disposed within the arc envelope 12 and the plug member 22 disposed within the dosing passageway 24 in accordance with embodiments of the present technique.

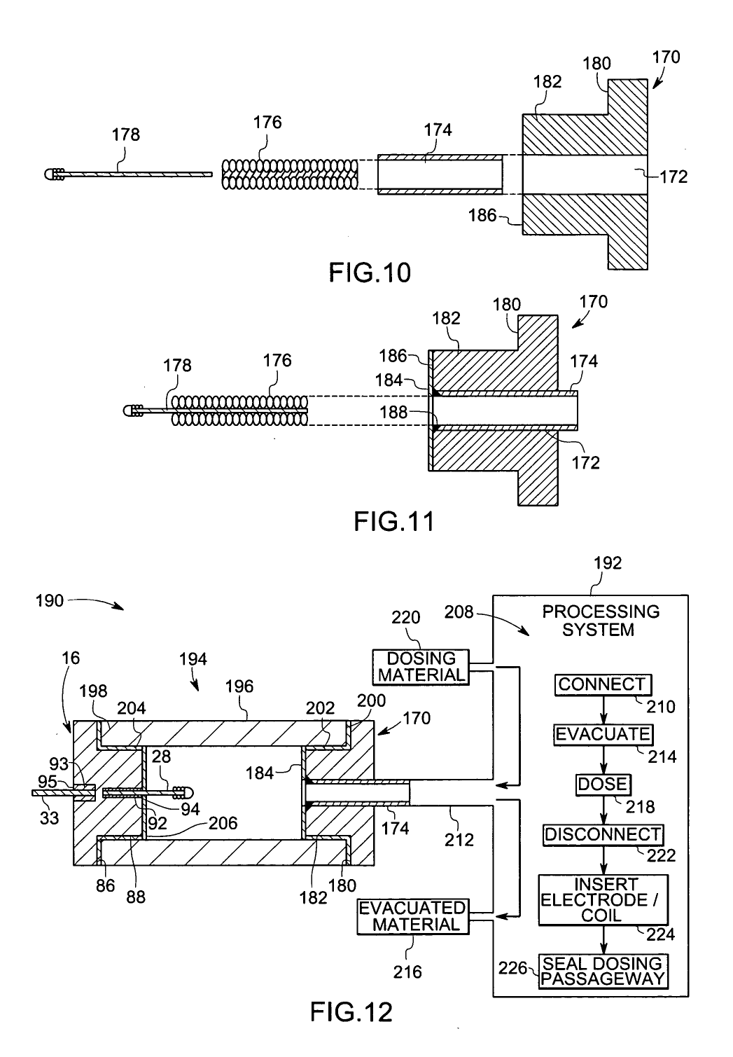

FIG. 10 is a cross-sectional view of an alternative end structure 170 having a dosing passageway 172, a dosing tube 174 exploded from the dosing passageway 172, a support structure (e.g., tube or coil) 176 exploded from the dosing tube 174, and an arc electrode 178 exploded from the coil 176 in accordance with embodiments of the present technique. As illustrated, the end structure 170 comprises an outer seal structure 180 and an inner seal structure 182. As discussed above with reference to the end structure 14 of FIGS. 1 and 2, the outer seal structure 180 is adapted to seal against an end of an arc envelope, whereas the inner seal structure 182 is adapted to plug into and seal against an inner surface of the arc envelope. Although a variety of materials combinations are within the scope of the present technique, the illustrated embodiment has a metal, niobium, molybdenum coated niobium, or cermet end structure 170, a molybdenum or molybdenum-rhenium dosing tube 174, a molybdenum coil 176, and a tungsten arc electrode 178.

Turning now to FIG. 11, the end structure 170 is illustrated partially assembled with the dosing tube 174 hermetically sealed within the dosing passageway 172 and a protective layer 184 disposed over an interior surface 186 of the end structure 170 in accordance with embodiments of the present technique. More specifically, the dosing tube 174 is inserted within the dosing passageway 172 and subsequently bonded to the end structure 170 at the interior surface 186. In this exemplary embodiment, a laser beam is applied about the periphery of the dosing tube 174 at the interior surface 186, such that a laser welded seal 188 is formed between the dosing tube 174 and the end structure 170. The protective layer 184, such as a molybdenum coating, is then applied over the interior surface 186 to protect the end structure 170 from corrosive materials disposed within the lamp, e.g., halide dose. As further illustrated in FIG. 11, the arc electrode 178 is inserted within the coil 176, which is later mounted in the dosing tube 174 as described in detail below. In addition, a seal material may be used to hermetically join the dosing tube 174 to the end structure 170.

Turning to FIG. 12, a system 190 having a processing system 192 is illustrated for dosing a lamp 194 in accordance with embodiments of the present technique. As illustrated in FIG. 12, the lamp 194 includes an arc envelope 196, the end structure 16 of FIG. 6 coupled to an end 198 of the arc envelope 196, and the end structure 170 of FIG. 11 coupled to an end 200 of the arc envelope 196. In the illustrated embodiment, the end structures 170 and 16 are hermetically sealed to the arc envelope 196 via seal materials 202 and 204, which are disposed between the interface of the end structures 170 and 16 and the arc envelope 196. Alternatively, other embodiments hermetically seal the end structures 170 and 16 to the arc envelope 196 via diffusion bonding, as described in detail above. Similar to the protective layer 184 disposed on the interior surface 186 of the end structure 170, the illustrated end structure 16 includes a protective layer 206, such as a molybdenum coating, to protect the end structure 16 from corrosive materials disposed within the lamp 194.

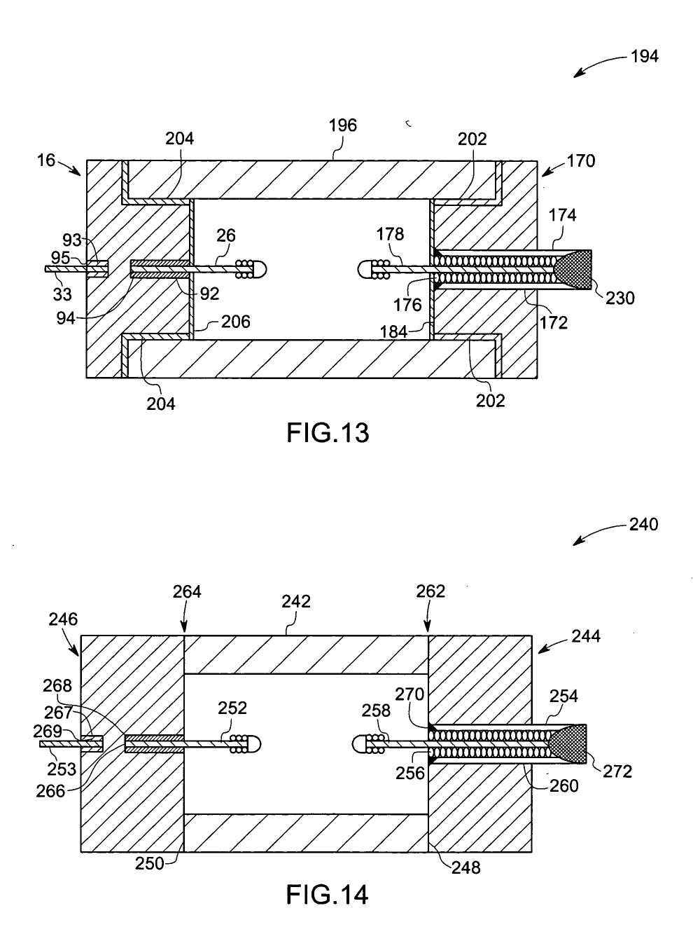

As further illustrated in FIG. 12, the lamp 194 is coupled to the processing system 192, which includes a dosing process 208 to dose the lamp 10 prior to sealing the dosing tube 174. At block 210, the process 208 begins by connecting the processing system 192 with the dosing tube 174 of the lamp 194. For example, tubing 212 can be connected between the processing system 192 and the dosing tube 174. At block 214, the process 208 evacuates material 216 from the lamp 194. At block 218, the process 208 injects a dosing material 220 into the lamp 194. At block 222, the process 208 proceeds to disconnect the processing system 192 from the dosing tube 174 of the lamp 194. With reference to FIGS. 11 and 13, the process 208 of FIG. 12 also inserts the assembly of the coil 176 and the arc electrode 178 into the dosing tube 174 of the lamp 194 (block 224). At block 226, the process 208 seals the dosing tube 174 about the coil 176 and the arc electrode 178, as illustrated in FIG. 13.

As discussed above with reference to FIG. 12, the hermetically sealed assembly of the lamp 194 is illustrated in FIG. 13. In the illustrated embodiment, the coil 176 and the arc electrode 178 are inserted one within the other inside the dosing tube 174, which is hermetically closed at a bond or seal 230. The coil 174 supports the arc electrode 178 within the dosing tube 174, while also permitting some freedom of movement and stress relaxation of the respective components. Regarding the seal 230, certain embodiments form the seal 230 by applying localized heat, such as a laser beam, onto the dosing tube 174, the coil one under 176, and the arc electrode 178. Alternatively, the dosing tube 174 may be formed of a ductile material, such as a niobium or molybdenum-rhenium alloy, which can be mechanically compressed by a crimping tool or other mechanical deformation tool to form the seal 230. In addition, localized heating can be applied to the seal 230 during or after the crimping process to improve the seal 230.

FIG. 14 is a cross-sectional view of an alternative lamp 240 having an arc envelope 242, end structures 244 and 246 butt-sealed to opposite ends 248 and 250 of the arc envelope 242, an arc electrode 252 shrunk-fit into the end structure 246, a lead wire 253 shrunk-fit into the end structure 246, a coil 256, and an arc electrode 258 hermetically sealed to a dosing passageway 260 of the end structure 244 in accordance with embodiments of the present technique. As illustrated, the lamp 240 has end-to-end or butt-seals 262 and 264 between the arc envelope 242 and the end structures 244 and 246, respectively. As illustrated, the end structures 244 and 246 are hermetically sealed with the arc envelope 242 by diffusion bonding of the materials at the interface between the end structures 244 and 246 and the arc envelope 242. In certain embodiments, localized heating, such as a laser, may be applied to this interface to facilitate diffusion bonding to form these butt-seals 262 and 264. Alternatively, the illustrated butt-seals 262 and 264 can include a seal material, such as described in detail above. In the illustrated embodiment, the end structure 246 is sintered to shrink-fit the arc electrode 252 and the lead wire 253 within an electrode receptacle 266 and a lead receptacle 267, respectively. Thus, this sintering process creates a sinter bond 268 between the arc electrode 252 and the electrode receptacle 266 and, also, a sinter bond 269 between the lead wire 253 and the lead receptacle 267. On the end structure 244, the dosing tube 254 can be used as a lead for the arc electrode 258. As discussed above with reference to FIGS. 11-13, the dosing tube 254 is hermetically sealed to the end structure 244 via localized heating (e.g., a laser weld) to form a bond 270. Moreover, the dosing tube 254 is hermetically closed about the coil 256 and the arc electrode 258 by a bond or seal 272, such as a crimped and/or locally heated bond.

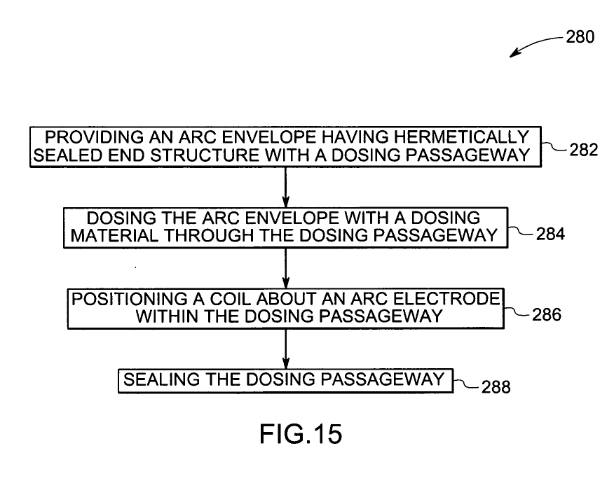

FIG. 15 is a flow chart illustrating an exemplary process 280 of manufacturing a lamp in accordance with embodiments of the present technique. With reference to the lamps described above with reference to FIGS. 10-14, the process 280 begins by providing an arc envelope having a hermetically sealed end structure with a dosing passageway (block 282). At block 284, the process 280 doses the arc envelope with a dosing material through the dosing passageway. At block 286, the process 280 positions a coil about an arc electrode within the doing passageway of the end structure. At block 288, the process 280 seals the dosing passageway about the coil and the arc electrode.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A lamp comprising:
an arc envelope; and
an end structure coupled to the arc envelope, wherein the end structure comprises at least one opening adapted to support an arc electrode and, to receive a dosing material into the arc envelope.

2. The lamp of claim 1, wherein the at least one opening comprises an arc electrode receptacle adapted to support the arc electrode and a dosing passageway adapted to receive the dosing material.

3. The lamp of claim 2, wherein the arc electrode receptacle is shrink-fit about the arc electrode.

4. The lamp of claim 2, comprising a plug disposed within the dosing passageway and hermetically sealed to the end structure.

5. The lamp of claim 1, wherein the at least one opening comprises a dosing tube disposed about the arc electrode.

6. The lamp of claim 5, comprising a coil or intermediate sized tube disposed between the dosing tube and the arc electrode.

7. The lamp of claim 6, wherein the coil or intermediate sized tube comprises molybdenum.

8. The lamp of claim 6, wherein the dosing tube, the coil, and the arc electrode are hermetically sealed to the end structure.

9. The lamp of claim 5, wherein the dosing tube comprises molybdenum.

10. The lamp of claim 5, wherein the dosing tube comprises an alloy of molybdenum rhenium.

11. The lamp of claim 1, wherein the arc envelope comprises a curved hollow structure.

12. The lamp of claim 11, wherein the curved hollow structure comprises an oval geometry.

13. The lamp of claim 11, wherein the curved hollow structure comprises a substantially spherical geometry.

14. The lamp of claim 1, wherein the end structure comprises a substantially flat structure adapted to butt and seal against an open end of the arc envelope.

15. The lamp of claim 1, wherein the end structure comprises a plug structure adapted to extend partially into and seal within an open end of the arc envelope.

16. The lamp of claim 1, wherein the arc envelope comprises a material selected from a group consisting of yttrium-aluminum-garnet, ytterbium-aluminum-garnet, micro grain polycrystalline alumina, polycrystalline alumina, sapphire, yttrium, spinel, ytterbium, yttrium-aluminum-gamet, and other garnet crystal structures.

17. The lamp of claim 1, wherein the end structure comprises a conductive material.

18. The lamp of claim 1, wherein the end structure comprises a cermet material.

19. The lamp of claim 1, wherein the end structure comprises niobium having a corrosion resistive coating

20. The lamp of claim 19, wherein the corrosion resistive coating comprises molybdenum.

21. A lamp, comprising:
means for shrink-fit mounting an arc electrode to an end structure; and
means for hermetically sealing the end structure with an open end of an arc envelope.

22. The lamp of claim 21, comprising means for dosing the arc envelope with a dosing material.

23. A lamp, comprising:
means for dosing an arc envelope through an end structure sealed to the arc envelope; and
means for mounting an arc electrode at least partially within the means for dosing.

24. The lamp of claim 23, comprising means for hermetically sealing the lamp.

25. The method of forming a lamp, comprising:
providing an arc envelope having a hermetically sealed end structure with a dosing passage;
dosing the arc envelope with a dosing material through the dosing passage;
positioning a support structure about an arc electrode at least partially within the dosing passage; and
sealing the dosing passage.

26. The method of claim 25, wherein providing comprises mounting a dosing tube within the dosing passage.

27. The method of claim 26, wherein mounting comprises providing the dosing tube formed of a material comprising molybdenum.

28. The method of claim 26, wherein mounting comprises providing the dosing tube formed of a material comprising molybdenum and rhenium.

29. The method of claim 25, wherein positioning comprises providing the support structure formed of a material comprising molybdenum.

30. The method of claim 25, wherein positioning comprises providing the support structure having a tube shape.

31. The method of claim 25, wherein positioning comprises providing the support structure having a coil shape.

32. The method of claim 25, wherein sealing comprises bonding together the coil, the arc electrode, and the dosing passage.

33. The method of claim 25, wherein bonding together comprises laser welding together the support structure, the arc electrode, and the dosing passage.

34. The method of claim 25, wherein providing comprises hermetically sealing the arc envelope to the end structure formed of a material comprising a cermet.

35. The method of claim 25, wherein providing comprises coating the end structure with a corrosion resistive material.

36. The method of claim 25, wherein coating comprises applying a molybdenum material to a surface of the end structure.

37. The method of forming a lamp, comprising:
providing an end structure having a receptacle;
inserting the arc electrode at least partially into the receptacle;
shrinking the end structure to compress the receptacle about the arc electrode; and
hermetically sealing the end structure to an open end of an arc envelope.

38. The method of claim 37, wherein providing the end structure comprises compacting a powder material to form the end structure.

39. The method of claim 37, wherein providing the end structure comprises mixing a ceramic and metal powder to form the powder material.

40. The method of claim 37, wherein providing the end structure comprises drilling the receptacle partially into the end structure.

41. The method of claim 37, wherein providing the end structure comprises first heating the end structure to partially condense the powder material prior to drilling the receptacle, and shrinking the end structure comprises second heating the end structure after drilling the receptacle and inserting the arc electrode to further condense the powder material.

42. The method of claim 37, wherein providing the end structure comprises heating the end structure to partially condense the powder material.

43. The method of claim 37, wherein shrinking the end structure comprises heating the end structure to condense the powder material and shrink the receptacle.

44. The method of claim 37, comprising forming a dosing passage through the end structure.

45. The method of claim 37, comprising filling the arc envelope with a dosing material through the dosing passage.

46. The method of claim 37, comprising inserting a plug into the dosing passage.

47. The method of claim 37, wherein hermetically sealing comprises sealing a flat side of the end structure against the open end of the arc envelope.

48. The method of claim 37, wherein hermetically sealing comprises sealing a plug portion of the end structure against and into the open end of the arc envelope.

49. The lamp comprising:
an arc envelope;
an end structure coupled to the arc envelope, wherein the end structure comprises at least one opening adapted to support an arc electrode and to receive a dosing material into the arc envelope; and
means for shrink-fit mounting the arc electrode to the end structure; and
means for hermetically sealing the end structure with an open end of an arc envelope.

50. The lamp comprising:
an arc envelope;
an end structure coupled to the arc envelope, wherein the end structure comprises at least one opening adapted to support an arc electrode and to receive a dosing material into the arc envelope; and
means for dosing the arc envelope through the end structure sealed to the arc envelope; and
means for mounting the arc electrode at least partially within the means for dosing.
